(19) United States
(12) Patent Application Publication
(10) Pub. No.: US 2008/0141002 A1
(43) Pub. Date: Jun. 12, 2008

(54) INSTRUCTION PIPELINE MONITORING DEVICE AND METHOD THEREOF

(75) Inventors: Ravindra N. Bhargava, Austin, TX (US); Benjamin T. Sander, Austin, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: ADVANCED MICRO DEVICES, INC., Sunnyvale, CA (US)

(21) Appl. No.: 11/608,697

(22) Filed: Dec. 8, 2006

(51) Int. Cl. G06F 9/38

(52) U.S. Cl. 712/220; 712/E09.062

(57) ABSTRACT

In accordance with a specific embodiment of the present disclosure, hardware periodically monitors a fetch cycle that fetches data associated with an address to determine performance parameters associated with the fetch cycle. Information related to the duration of a fetch cycle is maintained as well as information indicating the occurrence of various states and data values related to the fetch cycle. For example, the virtual address being processed during the fetch cycle is saved at the integrated circuit containing the fetch engine. Other performance-related parameters associated with execution of instructions at an execution engine of the pipeline are also monitored periodically. However, monitoring performance of the fetch engine is decoupled from monitoring performance-related events of the execution engine.

### FIELD OF THE DISCLOSURE

The present disclosure relates to data processing devices and more particularly to performance monitoring of data processing devices.

### BACKGROUND

The ability to record performance-related information for an instruction pipeline of a modern data processor is useful when determining how to optimize hardware and software of specific applications. However, the use of highly speculative fetch engines in modern instruction pipelines can limit the ability to identify and follow an instruction fetched at a fetch engine of a pipeline through its corresponding decode cycle, execution cycle and subsequent retirement. The ability to monitor performance events at a data processor and obtain useful data is further complicated when the instruction set being analyzed has variable size instructions that results in instructions residing at indeterminate locations of data being fetched by the fetch engine. The ability to monitor performance is further complicated when the execution or instructions results in the dispatch of varying numbers of operations that represent the instructions being executed. Therefore, a method and device capable of overcoming these problems would be useful.

### BRIEF DESCRIPTION OF THE DRAWINGS

FIG. 1 is a block diagram of a particular embodiment of a system level data processing device;

FIG. 2 is a block diagram of a particular embodiment of a microprocessor unit of FIG. 1;

FIG. 3 is a flow diagram of a particular embodiment of a method of monitoring performance information in a fetch portion of an instruction pipeline;

FIG. 4 is a flow diagram of a particular embodiment of a method of monitoring performance information in the data access phase of an execution portion of an instruction pipeline;

FIG. 5 is a diagram illustrating a particular embodiment of a method of recording performance information in a portion of an instruction pipeline;

FIG. 6 is a flow diagram illustrating a particular embodiment of a method of monitoring performance information in an fetch portion and in an execution portion in a decoupled fashion;

FIG. 7 is a block diagram of a particular embodiment of an event counter to trigger recording of performance information in an instruction pipeline.

### DETAILED DESCRIPTION

In accordance with a specific embodiment of the present disclosure, hardware periodically monitors a fetch cycle that fetches data associated with an address to determine performance parameters associated with the fetch cycle. Information related to the duration of a fetch cycle is maintained as well as information indicating the occurrence of various states and data values related to the fetch cycle. For example, the virtual address being processed during the fetch cycle is saved at the integrated circuit containing the fetch engine. Other performance-related parameters associated with execution of instructions at an execution engine of the pipeline are also monitored periodically. However, monitoring performance of the fetch engine is decoupled from monitoring performance-related events of the execution engine. Specific embodiments in accordance with the present disclosure will be better understood with reference to the attached figures.

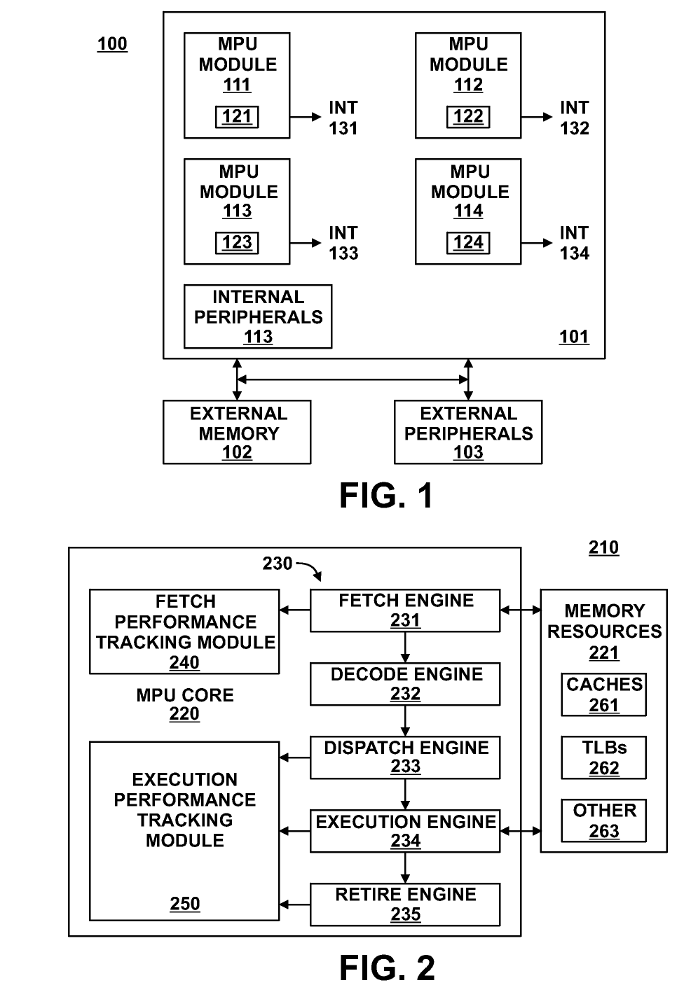

Referring to FIG. 1, a block diagram of a particular embodiment of a system level data processing device 100 is illustrated. The system level device 100 may be a desktop computer, server computer, workstation, portable device, and the like. The system level device 100 includes a microprocessor 101, an external memory 102, and external peripherals 103. The external memory 102 and the external peripherals 103 are connected to the microprocessor 101 via one or more data busses and can themselves include multiple devices. For example, external peripherals 103 can include a plurality of data processing devices, which can include other microprocessors, that can be bus master devices and slave devices.

The microprocessor 101 includes microprocessor unit (MPU) modules 111, 112, 113, and 114. It will be appreciated that although the microprocessor 101 is illustrated as having multiple microprocessor modules, in another particular embodiment the microprocessor 101 can include a single MPU module. The microprocessor 101 also includes internal peripherals 115, which can include resources that operate independent from MPU modules 111-114, or resources that are accessible by each of the MPU modules 111-114, such as memory controllers, communication modules, slave devices, additional processing modules, data caches, and the like. Each of the MPU modules 111-114 includes a performance tracking module, including performance tracking modules 121, 122, 123, and 124 respectively. In addition, each of the MPU modules can include peripherals primarily dedicated to that MPU module.

During operation, each of the MPU module 111-114 includes an instruction pipeline that executes program instructions. During execution of an instruction at an MPU module that is being tracked, the performance tracking module of that module obtains performance tracking information associated with operation of the instruction pipeline. For example, the performance tracking module 121 obtains performance information at MPU module 111 associated with fetching of data by the fetch engine of the instruction pipeline during a fetch cycle and the execution and retirement of operations during execution and retirement cycles of the execution and retirement engines, respectively, of the instruction pipeline. Therefore, the performance tracking module 121 can store and provide performance related information for different portions of the instruction pipeline, such as the fetch engine and the execution engine.

The performance information that is obtained can represent a wide variety of information. For example, performance information related to the fetch portion of the instruction pipeline can indicate the occurrence of specific states and log specific data values encountered during a fetch cycle. Such performance information can include information indicating the duration of a fetch cycle, whether an instruction cache hit or miss occurred, the success of translation lookaside buffer (TLB) accesses, and other information related to a monitored fetch cycle. For example, the occurrence of a state indicative of an instruction cache miss during a fetch cycle can be stored in response to a cache miss occurring in response to the fetch cycle. In addition, specific data, which can be related on the occurrence of a particular state, can include information indicating when the instruction pipeline of the MPU module 111 accesses external memory 102, the page size of a memory location translated at a translation look-aside buffer (TLB), and the like.

Further, the performance related information can be obtained periodically according to a particular sampling interval. For example, a fetch sampling interval can identify a specific fetch cycle at which performance information is to be stored, so that it can be accessed by a software handler and subsequently analyzed. The sampling interval can be based on number of events such as a number of clock cycles, a number of retired instructions, a number of completed instruction fetches, and the like. In addition, the recording of performance data in each portion of the instruction pipeline may be decoupled from the tracking of information in other portions. The term decoupled as used with regard to portions of the instruction pipeline is intended to mean that the sampling information associated with a specific type cycle of a pipeline, e.g., the fetch cycles of the fetch engine, is independent of the sampling of information associated with a different type cycles of the pipeline, e.g., the execution cycles of the execution engine. For example, the tracking of performance information in the fetch engine may be recorded for a fetch cycle of an address based on a first sampling interval, while the tracking information in the execution portion of the instruction pipeline is recorded in accordance with a second sampling interval that does not occur as a result of the occurrence of the first sampling cycle. In other words, information accessed as the result of a specific address being fetched at the fetch engine is not tracked through subsequent pipeline stages for the purpose of obtaining performance related information that resulted from the execution of an instruction associated with the fetched information. Instead, instructions being executed at the execution engine of the pipeline can be sampled independently for tracking.

Upon completion of a specific pipeline cycle, e.g., the fetch cycle, being sampled, the related performance tracking module can generate an interrupt to allow software access of the performance data obtained during the sampling cycle. For example, interrupt 131 may be asserted in response to the completion of a fetch cycle at the fetch engine of the instruction pipeline of the MPU module 111. In response to the asserted interrupt 131, a software application can determine whether to access the stored performance information for subsequent analysis. Saved performance information from decoupled sampling operations can be subsequently analyzed. The analysis can determine whether any correlation exists between sets of information that is acquired a decoupled manner as described. For example, performance events associated with a fetch cycle of a particular address can be correlated with performance events associated with execution of instructions at the same address, when the decoupled operation results in the same address being monitored during a fetch cycle and an execution cycle. This decoupled hardware acquisition of performance information at different portions of the instruction pipeline allows for a simplified hardware implementation for monitoring performance, while permitting subsequent software correlation of information acquired in a decoupled manner. Correlation can be determined based on the virtual instruction address associated with each cycle, the physical instruction address, or other appropriate information.

In one embodiment, performance information indicating that the instruction pipeline has accessed a memory which is not dedicated. As used herein, a memory is ‘dedicated’ to an instruction pipeline if 1) a request for a specific number of bytes at a particular address in the memory can be made directly by an operation in the instruction pipeline, and 2) the valid data are returned from the memory at the granularity of the request directly back to the instruction pipeline. The performance tracking module can identify which operation resulted in the memory access and can record performance information regarding the memory access and associate that recorded performance information with the operation that resulted in the access.

Referring to FIG. 2, a block diagram of an MPU module 210, corresponding to a specific embodiment of one or more of the MPU modules 111-114 of FIG. 1, is illustrated. The MPU module 210 includes an MPU core 220 coupled to memory resources 221. The MPU core 220 includes an instruction pipeline 230, a fetch performance tracking module 240, and an execution performance tracking module 250. The instruction pipeline 230 includes a fetch engine 231, a decode engine 232, a dispatch engine 233, an execution engine 234, and a retire engine 235. The fetch engine 231 includes an output connected to an input of the fetch performance correcting module 240, and an output connected to an input of the decode engine 232. The fetch engine 231 also includes a bidirectional connection to the memory resources 221. The decode engine 232 includes an input connected to the output of the fetch engine 231, and an output. The dispatch engine 233 includes an input connected to an output of the decode engine 232, and two outputs. The execution engine 234 includes an input coupled to an output of the dispatch engine 233, and two outputs. The execution engine 234 also includes a bidirectional connection to the memory resources 221. The retire engine 235 includes an input connected to an output of the execution engine 234 and an output. The execution performance tracking module 250 includes inputs connected to outputs of the dispatch engine 233, execution engine 234, and the retire engine 235. The memory resources 221 include one or more of caches 261, one or more translation lookaside buffers 262, and a memory controller 263. The memory controller 263 is used to access memory external to the MPU module 210. The caches 261 can include an instruction cache, a data cache, shared caches, and the like. Similarly, the TLBs 262 can include instruction TLBs, data TLBs, and shared TLBs. It will be appreciated that there can be many connections between the engines of the instruction pipeline and that FIG. 2 represents a high level block diagram considering the ultimate flow of instruction bytes and data access bytes through a pipeline.

During operation, the instruction pipeline accesses and executes instruction associated with programs operating on the MPU core 220. The fetch engine 231 fetches instruction data based at addresses provided by the MPU core 220. In particular, based on an address, the fetch engine 231 determines if data associated with that address is available in the caches 261, and whether the data associated with the virtual address being accessed was translated to a physical address by data stored at a TLB buffer at the TLBs 262. If the instruction data associated with the address is not available at memory resources 221, the information can be fetched by a memory controller, which can be part of the module 263, to retrieve the instruction data from a location external module 210. For example, the information can be retrieved from memory resources at other memory resources associated with another MPU module at the integrated circuit, or at a memory location that is external the integrated circuit. The fetch performance tracking module 240 periodically tracks performance information for the fetch engine 231. The performance tracking of a fetch cycle at the fetch engine 231 does not result in any performance tracking at portions of the pipeline 230 subsequent to the fetch engine.

The decode engine parses the instruction data received from the fetch engine 231 to determine the next instructions in the accessed instruction data. Based on the parsed instructions, the decode engine 232 determines one or more operations used to implement that instruction. It will be appreciated that an operation can be a mico-code operation, hardware operation, and the like. The dispatch engine 233 receives the one or more operations used to implement a specific instruction and determines which execution unit of the execution engine 234 should receive each of the operations. The dispatch engine 233 is connected to the execution performance tracking module to allow one operation of the set of operations that implement the instruction to be tracked. The tracked operation for a given instruction can be randomly selected from the plurality of operations implanting the instruction, can be at a fixed location relative the plurality of operations, or can be selected from the plurality of operations based upon other criteria. The selected operation is executed at the execution engine 234. During execution of the tracked operation, the execution performance tracking module 250 obtains information related to the execution of the operation. For example, an operation may be an arithmetic operation, a load operation, a store operation, a NOP operation, and the like. With respect to a load/store operation, the execution performing tracking module 250 can obtain information indicating whether an address associated with the operation was located in one of the caches 261, whether an address associated with an operation was located in the translation lookaside buffers 262, and whether a memory controller, e.g. at other 263, was used to retrieve data or addresses.

After execution of an operation at execution engine 234, the results are provided to the retire engine 235, which determines whether an instruction can be retired based on the received information. The retire engine 235 can provide information regarding the retirement of instructions to the execution performance tracking module 250. The execution performance tracking module 250 can determine the duration of an execution cycle and retire cycle for a specific operation by monitoring states that indicate when the execution and retirement of an operation is completed.

It will be appreciated that the fetch performance tracking module 240 and the execution performance tracking module 250 are decoupled from each other. For example, performance information can be obtained for the execution of a specific instance of an instruction at the execution engine 234, even though no performance information was obtained for the same instance of the instruction when it was fetched by the fetch engine 231. It will be appreciated, therefore, that the sampling period for each tracking module may be similar, so that the information recorded by each module has similar granularity, or that the sampling period for each tracking module can different, so that the information recorded by each module has different granularity.

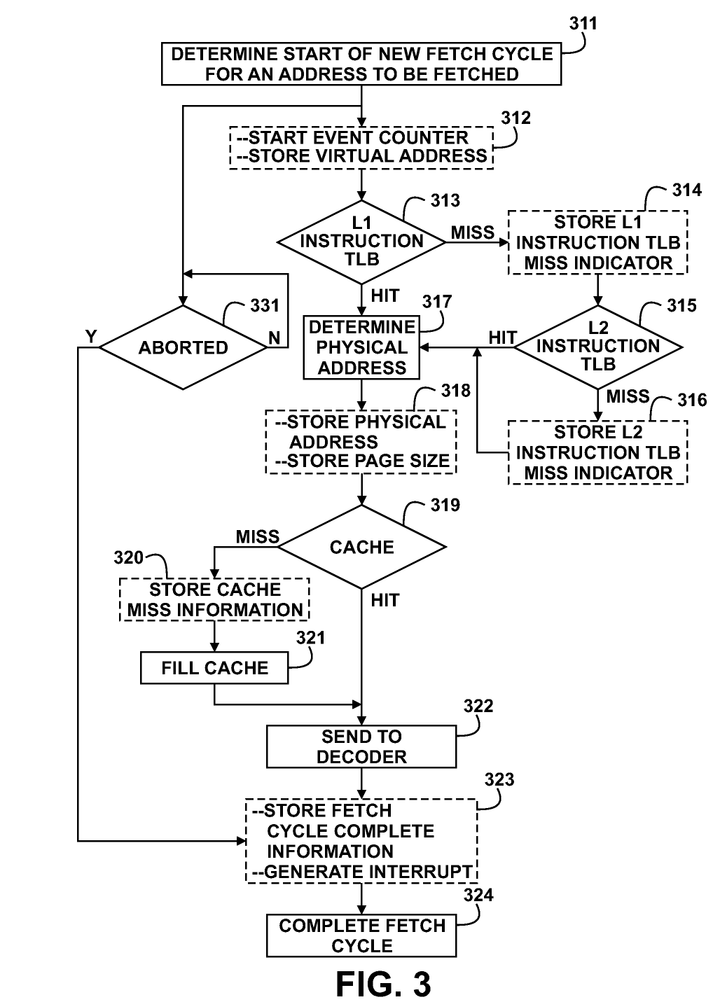

Referring to FIG. 3, a flow diagram of a method of monitoring performance information in a fetch portion of an instruction pipeline is illustrated in accordance with a specific embodiment. The flow diagram of FIG. 3 illustrates performance monitoring for a particular fetch cycle of the fetch portion. As used herein, the term fetch cycle is intended to mean the actions taken by the fetch engine of a pipeline in the process of fetching data for a particular instruction address. A fetch cycle for a particular instruction address starts when the instruction address is at a first stage of the fetch engine, and ends when the fetch is completed. The term completed as used with respect to a fetch cycle is intended to mean when either a fetch completes normally or a fetch is aborted. The term complete normally as used with respect to a fetch cycle is intended to mean the instruction data has been fetched and provided to the decode engine. The term aborted as used with respect to a fetch cycle is intended to mean a fetch cycle was terminated prior to data being fetched being provided to the decode engine.

At block 311 a new address to be fetched is determined. This represents the start of the fetch cycle for the new address at an integrated circuit. In a particular embodiment, it is unknown whether the determined new address is aligned with the start of an instruction, and also if the length of an instruction associated with the new address is unknown to the fetch portion. Accordingly, the performance information that is tracked for the fetch portion of the instruction pipeline will be associated with the determined address range, rather than with a particular instruction.

As illustrated, the method can proceed from block 311 along two paths. The first path, through block 312 represents a fetch cycle that is completed normally when completed in its entirety. The second path, through decision block 331 represents completion of the fetch cycle being executed along the first path in response to an event that aborts the fetch cycle prior to completion sending information to the decoder. In particular, proceeding to decision block 331, the fetch portion determines whether the fetch cycle has been aborted. If the fetch cycle has not been aborted the method returns to block 331. If the fetch cycle has been aborted the method along the first branch proceeds to block 323. It will be appreciated that although the decision block 331 is illustrated as branching after block 311 the fetch cycle can be aborted at any point during the fetch cycle. The fetch cycle can be aborted by another portion of the instruction pipeline, and by other appropriate modules of a processor core.

Returning to the first path, at block 312 an event counter is started to record the length of the fetch cycle. Note that dashed blocks of FIG. 3 represent events related to tracking the performance of a fetch cycle. In a particular embodiment, the event counter records clock cycles for the fetch portion. In an alternative embodiment, the contents of a free running counter are recorded to be used later to determine the length of the fetch cycle. In addition, at block 312 a virtual address is stored at a memory location of the integrated circuit in response to a start of a new fetch cycle being addressed. The virtual address is associated with the address determined at block 311.

Proceeding to decision block 313, the hit or miss state of a level one translation lookaside buffer is determined. Note that for purposes of example, the diagram of FIG. 3 illustrates the use of two TLB levels. It will be appreciated that fewer TLB levels or more TLB levels can be used. If the address associated with the fetch cycle cannot be translated a state indicative of a L1 TLB miss is generated and flow proceeds to block 314. If the address being fetched can be translated at the L1 TLB a state indicative of a L1 TLB hit is indicated and flow proceeds to block 318. At block 314 an indicator representing the level 1 TLB miss state being encountered is stored. The flow proceeds to decision block 315, where the occurrence of a L2 TLB hit or miss is determined. If a hit on the level 2 TLB is indicated the method proceeds to decision block 318. If a TLB miss is indicated the method proceeds to block 316.

At block 316 an indicator representing the occurrence of a level 2 TLB miss is stored and flow proceeds to block 317. At block 317 a physical address is determined for the virtual address in the event no TLB hit was encountered, and flow proceeds to block 318.

At block 318, the physical address of the instruction data being fetched is stored at a memory location of the integrated circuit. In addition a page size associated with the physical address is stored. The method proceeds to decision block 319 where the hit or miss state of an instruction cache is determined. If the instruction cache includes information associated with the virtual address this indicates a cache hit and the method proceeds to block 322. If the state of the cache indicates that the information associated with the virtual address is not available in the cache this indicates a cache miss and the method proceeds to block 320 where a cache miss indicator is stored. The method then moves to block 321 and the cache is filled with the information associated with the virtual address. The method proceeds to block 322 and the retrieved information based on the virtual address is sent to the decoder portion 322. It will be appreciated by one skilled in the art that the blocks of the diagram of FIG. 3 are illustrated as serial in nature for purposes of discussion only, and that functions associated with various blocks can occur in parallel at a microprocessor module. For example, a cache access operation can begin in parallel with access of the L1 and L2 TLB.

Moving to block 323 the cycle counter started in block 312 is stopped, thereby recording the duration of the fetch cycle. In alternative embodiment, the contents of a free running counter are stored, whereby the length of the fetch cycle can be calculated based on the stored value. In addition, at block 323, information associated with completing the fetch cycle is indicated. For example, information indicating that the fetch cycle resulted in information being provided to the decoder is recorded at a memory location of the integrated circuit. In addition, an interrupt is generated indicating an information handler to retrieve the stored fetch cycle information. At this point, it has been determined that the fetch cycle is completed. The method proceeds to block 324 and the fetch cycle is completed. The performance information stored during the fetch cycle is maintained after the end of the fetch cycle so that it is available for the information handler or other programs to record the information for subsequent analysis.

It will be appreciated that while the events outlined in FIG. 3 have been illustrated in a sequential fashion, one or more of the events may take place in parallel. For example, accesses to the level 1 and level 2 translation lookaside buffers may occur in parallel with determining the state of the cache.

In addition, it will be appreciated that the fetch engine of the execution pipeline is typically implemented in a series of stages, with a fetch cycle being represented by the movement through the series of stages in a pipelined fashion. For example, while one fetch cycle is at a first stage of the fetch engine, such as the address determination stage, another fetch cycle can be at a second stage of the pipeline, such as the cache access stage. It will be appreciated that a stall condition can occur at a particular stage of a fetch cycle in response to data not being available within an expected number of cycles. In the event of a stall condition, the stored performance information associated with the fetch cycle experiencing the stall is maintained, and the fetch cycle is reinitiated at the beginning of the fetch engine. When this occurs, fetch cycles in stages prior to the stage containing the fetch cycle experiencing the stall are flushed, and the stored performance information associated with those fetch cycles is not maintained. When the fetch cycle causing the stall is reissued at the first stage of the fetch engine, the performance information is reset and the fetch cycle being reissued becomes the sampled cycle. In an alternate embodiment, a sampled fetch cycle that is flushed due to a stall can report the stall and terminate the sampling cycle.

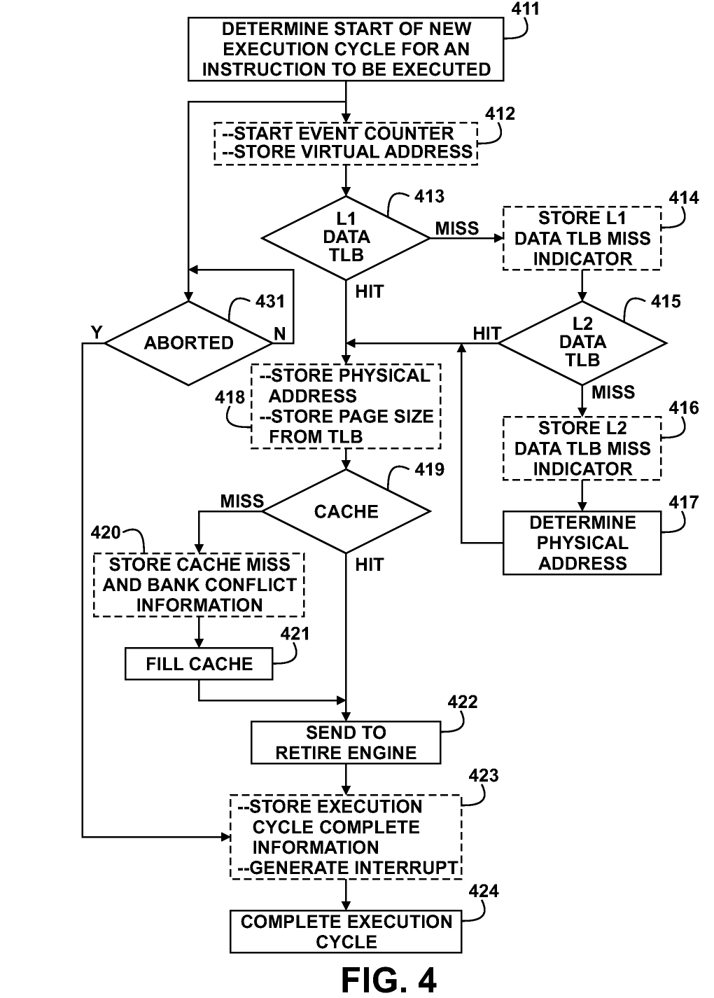

Referring to FIG. 4, a flow diagram of a specific implementation of monitoring performance information in an execution engine of an instruction pipeline is illustrated. The flow diagram illustrates performance monitoring for a particular execution cycle of an operation that results in a load or store request. As used herein, the term execution cycle is intended to mean the actions, from start to completion, taken by the execution engine for a particular operation until the execution cycle is terminated.

At block 411 an operation to be executed is determined. The operation is associated with a particular instruction, which can be translated into multiple operations by the decoder. Determining the operation represents the start of the execution cycle for the operation. Note that the execution performance monitoring module can determine which operation of an instruction is being monitored based upon information received from the dispatch engine.

As illustrated, the method can proceed from block 411 along two paths. The first path, through block 412 represents normal execution of an operation. The second path, through decision block 431 represents aborting of the execution cycle prior to completion of the execution. In particular, proceeding to decision block 431, the execution portion determines whether the execution cycle has been aborted. If the execution cycle has not been terminated the flow returns to block 431. If the execution cycle has been terminated the method proceeds to block 423. It will be appreciated that although the decision block 431 is illustrated as branching after block 411, aborting the execution cycle can occur at any point during the execution cycle and will terminate flow along the path including block 413. The execution cycle can be aborted by another portion of the instruction pipeline or by other appropriate modules of a processor core.

Returning to the first path, at block 412 an event counter is started to record the length of the execution cycle. Note that dashed blocks of FIG. 4 represent events related to tracking the performance of an execution cycle. In a particular embodiment, the event counter records clock cycles for the execution portion. In an alternative embodiment, the contents of a free running counter are recorded to be used later to determine the length of the execution cycle. In addition, at block 412 a virtual address of the instruction associated with the operation being executed is stored at a memory location of the integrated circuit in response to a start of a new execution cycle. Further, at block 412 a physical address of the instruction associated with the operation being executed is stored at a memory location of the integrated circuit in response to a start of a new execution cycle.

Blocks 413-421 are analogous to blocks 313-321 of FIG. 3 for data accesses typically associated with the execution of load or store operations. It will be appreciated that many operations do not access cacheable data, and the diagram of FIG. 4 is illustrative.

At block 422 information relating to completed execution of the operation is provided to the retire engine. At block 423 the cycle counter started in block 412 is stopped, thereby recording the length of the execution cycle. In an alternative embodiment, the contents of a free running counter are stored and the length of the execution cycle calculated based on the stored value. In addition, at block 423 information associated with completing the execution cycle is indicated. For example, information indicating that the execution cycle resulted in information being provided to the retire portion of the pipeline is recorded at a memory location of the integrated circuit. In addition, an interrupt is generated indicating an information handler to retrieve the stored execution cycle information. At this point, it has been determined that the execution cycle is completed. The method proceeds to block 424 and the execution cycle is ended. The execution cycle information stored is maintained after the end of the execution cycle so that it is available for the information handler or other programs to record the information for subsequent analysis. Note in an alternate embodiment, an interrupt is not generated by the execution performance tracking module until the instruction associated with the operation is retired or aborted.

It will be appreciated that while the events outlined in FIG. 4 have been illustrated in a sequential fashion, one or more of the events may take place in parallel. It will further be appreciated that other types of operations may result in different events, and recording of different performance information, than set forth in FIG. 4. For example, branch operations can result in branch types and other information being stored. For load and store operations, communication information such as store to load data forwarding can be recorded. In another embodiment, arithmetic operations can be monitored. Further, for all instruction types, performance information such as scheduling information and pipe stage latencies can be monitored and recorded.

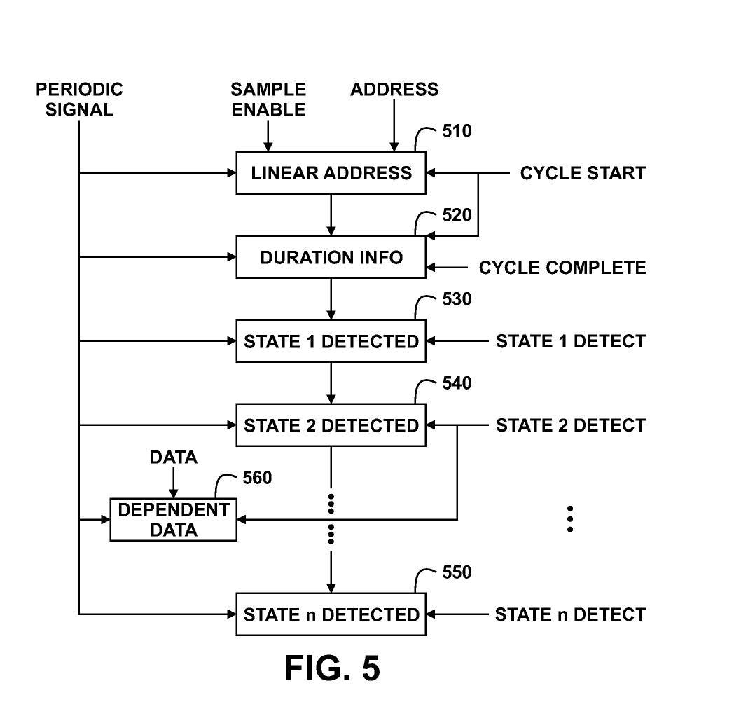

Referring to FIG. 5, a block diagram illustrating a portion of a performance tracking module, such as fetch performance tracking module 240 or execution performance tracking module 250, is illustrated. Memory location 510 stores a virtual address in response to both a cycle start signal and periodic signal being asserted. The cycle start signal is asserted in response to a state indicating the start of a cycle at an engine of the pipeline. For example, the cycle start signal may indicate the start of a fetch cycle, an execution cycle, and the like. The periodic signal is asserted by a performance monitoring module to indicate a cycle associated with a specific portion a pipeline, such as a fetch or execution cycle, should be monitored.

Memory location 520 stores duration information in response to assertion of the cycle start signal, a cycle complete signal, and the periodic signal being asserted. The cycle complete signal is asserted in response to a state indicating the completion of the cycle being monitored. The duration information can include information from free-running timers, or a single value from resettable counter registers.

Memory location 530 stores an indication that a first state has occurred in response to both a State 1 Detect signal and the Periodic signal being asserted. The State 1 Detect Signal is asserted in response to a specific state occurring in response to a specific cycle. For example, state 1 can represent a state, such as a cache miss, that occurred as a result fetching instruction data during an instruction fetch cycle.

Memory location 540 stores an indication that a second state has occurred in response to both a State 2 Detect Signal and the Periodic Signal being asserted. The State 2 Detect Signal is asserted in response to a specific state occurring during a functional cycle of a pipeline. For example, state 2 can represent a state, such as a TLB hit, that occurred as a result fetching instruction data during an instruction fetch cycle. Memory location 560 stores data that is related to the occurrence, or non-occurrence of state 2. For example, when a TLB hit occurs, the physical address of an instruction fetch cycle can be stored.

Block 550 indicates that any number of states can be tracked in accordance with the present disclosure.

Exemplary states that can correlate to state 1, state 2, and state N of FIG. 5, and associated dependent information, that may be recorded for a fetch portion of an instruction pipeline are set forth in the following table:

| | | Fetch Related | Fetch Related Data |
|---|---|---|---|
| State Name | State Description | Data | Description |
| | | Fetch cycle | This data provides the virtual |
| | | virtual address | address of the fetch cycle being |
| | | | sampled |
| L2 TLB miss | This state indicates that the | | |
| | fetch cycle resulted in a miss | | |
| | at the 2^{nd} level TLB. | | |
| L1 TLB miss | This state indicates that the | | |
| | fetch cycle resulted in a miss | | |
| | at the 1^{st} level TLB. | | |
| | | Translated | This data provides the page |
| | | page size | size of the translation during |
| | | | the fetch cycle. |
| Fetch Cycle | This state indicates that a | | |
| physical address | valid physical address has | | |
| valid | been obtained for the fetch | | |
| | cycle virtual address | | |
| | | Fetch cycle | This data provides the physical |
| | | physical | address of the fetch cycle. |
| | | address | Note, in one embodiment, |
| | | | depending on the page size and |
| | | | paging mode, the lowest order |
| | | | bits of the physical address will |
| | | | match those of the virtual |
| | | | address and do not have to be |
| | | | stored. |
| Instruction cache | This state indicates that the | | |
| miss | fetch cycle resulted in an | | |
| | instruction cache miss. | | |
| Instruction fetch | This state indicates that data | | |
| delivered | being accessed by the fetch | | |
| | cycle is available and ready | | |
| | for use by the instruction | | |
| | decoder. | | |
| Instruction cycle | This state indicates that new | | |
| valid | instruction fetch cycle data | | |
| | is available. | | |
| | | Instruction | This data provides the duration |
| | | fetch latency | of the fetch cycle. In one |
| | | | embodiment, the number of |
| | | | clock cycles from when the |
| | | | instruction fetch was initiated |
| | | | to when the data was delivered |
| | | | to the decode engine is stored. |
| | | | If the instruction fetch is |
| | | | terminated before the fetch |
| | | | completes, this field returns the |
| | | | number of clock cycles from |
| | | | when the instruction fetch was |
| | | | initiated to when the fetch was |
| | | | terminated |
| Fetch Stall Type | This set of states indicates | | |
| Vector | the source of the fetch stalls | | |
| | encountered by the tagged | | |
| | fetch | | |
| | | Valid bytes | This data provides how many |
| | | fetched | of the fetched bytes are valid |
| | | | based on the fetch pointer and |
| | | | branch prediction information. |

Exemplary states, and associated dependent information, that may be recorded for an execution portion of an instruction pipeline are set forth in the following table:

| | | Execution | Execution Related |
|---|---|---|---|
| State Name | State Description | Related Data | Data Description |
| | | Operation | This data provides the |
| | | virtual address | virtual address of the |
| | | | instruction that contains |
| | | | the operation being |
| | | | sampled |
| | | Operation | This data provides the |
| | | physical | physical address of the |
| | | address | instruction that contains |
| | | | the operation being |
| | | | sampled |
| Operation | This state indicates that new | | |
| sample valid | instruction execution cycle data | | |
| | available. | | |
| Branch | This state indicates that the operation | | |
| operation | was a branch operation | | |
| Mispredicted | This state indicates that the operation | | |
| branch | was a branch operation that was | | |
| operation | mispredicted. | | |
| Taken branch | This state indicates that the operation | | |
| operation | was a branch operation that was | | |
| | taken. | | |
| Return | This state indicates that the operation | | |
| operation | was a return operation. | | |
| Mispredicted | This state indicates that the operation | | |
| return operation | was a return operation that was | | |
| | mispredicted. | | |
| Resync | This state indicates that the operation | | |
| operation | was a micro-coded fetch resync | | |
| | operation. | | |
| | | Operation tag | This data provides the |
| | | to retire count | number of cycles from |
| | | | when the execution |
| | | | cycle sampling the |
| | | | operation started to |
| | | | when the operation was |
| | | | retired. |
| | | Operation | This data provides the |
| | | completion to | number of cycles from |
| | | retire count | when the operation was |
| | | | speculatively completed |
| | | | to when the operation |
| | | | was retired. |
| IBS request | This state indicates whether a request | | |
| destination | is serviced at local processor or a | | |
| processor | remote processor. | | |
| Memory | This state indicates which local cache | | |
| Controller Data | returned the data | | |
| Source: Local | | | |
| Shared Cache | | | |
| Memory | This state indicates data was returned | | |
| Controller Data | from another CPU's cache or a | | |
| Source: Other | remote shared cache | | |
| MPU Cache | | | |
| Memory | This state indicates data was returned | | |
| Controller Data | from external memory | | |
| Source: External | | | |
| Memory | | | |
| Memory | This state indicates data was returned | | |
| Controller Data | from other address spaces, such as | | |
| Source: Other | memory mapped input/output | | |
| | modules or interrupt controller | | |
| | addresses | | |
| Cache | This state indicates the coherency | | |
| coherency state | state of the data in the cache | | |
| | | Data cache | This data provides a |
| | | miss latency | duration, such as the |
| | | | number of clock cycles, |
| | | | from when a miss is |
| | | | detected in the data |
| | | | cache to when the data |
| | | | was delivered to the |
| | | | execution engine. |
| | | Data cache | This data provides the |
| | | physical | physical address of a |
| | | address valid | memory operation. |
| | | Data cache | This data provides the |
| | | virtual address | virtual address of a |
| | | valid | memory operation. |
| Hit on an | This state indicates a load or store | | |
| outstanding data | operation of the execution cycle | | |
| cache miss | resulted in a hit on an already | | |
| request | allocated data cache miss request. | | |
| Locked | This state indicates that the load or | | |
| operation | store operation of the execution cycle | | |
| | is a locked operation. | | |
| | | Memory | This data provides the |
| | | Access Type | type of memory |
| | | | accessed by a load or |
| | | | store operation. For |
| | | | example, write |
| | | | combining type or |
| | | | uncacheable type. |
| Data forwarding | This state indicates data forwarding | | |
| from store to | from a store operation to a load was | | |
| load operation | cancelled. | | |
| cancelled | | | |
| Data forwarded | This state indicates data for a load | | |
| from store to | operation was forwarded from a store | | |
| load operation | operation. | | |
| Bank conflict on | This state indicates that a load or | | |
| store operation | store operation of the execution cycle | | |
| | encountered a bank conflict with a | | |
| | store operation in the data cache | | |
| Bank conflict on | This state indicates that a load or | | |
| load operation | store operation of the execution cycle | | |
| | encountered a bank conflict with a | | |
| | load operation in the data cache | | |
| Misaligned | This state indicates that a load or | | |
| access | store operation of the execution cycle | | |
| | crosses a cache storage boundary. | | |
| Data cache miss | This state indicates that the cache line | | |
| | used by the load or store of the | | |
| | execution cycle was not present in the | | |
| | level one data cache. | | |
| Data cache L2 | This state indicates that the physical | | |
| TLB hit | address for the load or store operation | | |
| | of the execution cycle was present in | | |
| | the data cache L2 TLB. | | |
| Data cache | This state indicates that the physical | | |
| L1TLB | address for the load or store operation | | |
| | of the execution cycle was present in | | |
| | the data cache L1 TLB. | | |
| | | Data | This data provides the |
| | | translation | page size corresponding |
| | | page size | to a data address |
| | | | translation |
| Data cache | This state indicates that the physical | | |
| L2TLB miss | address for the load or store operation | | |
| | of the execution cycle was not present | | |
| | in the data cache L2 TLB. | | |
| Data cache | This state indicates that the physical | | |
| L1TLB miss | address for the load or store operation | | |
| | of the execution cycle was not present | | |
| | in the data cache L1 TLB. | | |
| Store op | This state indicates that the operation | | |
| | of the execution cycle is a store | | |
| | operation | | |
| Load op | This state indicates that the operation | | |
| | of the execution cycle is a load | | |
| | operation | | |
| | | Total | This data provides the |
| | | Operations | total number of |
| | | | operations associated |
| | | | with an instruction being |
| | | | sampled during an |
| | | | executions cycle |
| | | Sampled | This data provides |
| | | Operation | which one of the Total |
| | | | Operations was sampled |
| Instruction | This state indicates that the | | |
| ready for retire | instruction that contains the operation | | |
| | is ready for retirement | | |
| Instruction | This state indicates that the | | |
| retired | instruction that contains the operation | | |
| | is retired | | |
| Operation ready | This state indicates that the operation | | |
| for dispatch | is ready to be dispatched to an | | |
| | execution unit | | |
| Operation | This state indicates that the operation | | |
| dispatched | has been dispatched to an execution | | |
| | unit | | |
| Execution cycle | This state indicates that the execution | | |
| complete | cycle has been completed | | |
| Execution cycle | This state indicates that the execution | | |
| aborted | cycle has been aborted | | |
| | | Assigned | This data provides |
| | | Execution Unit | which execution |
| | | | resource executed a |
| | | | tagged operation |
| Memory | This state indicates that a tagged | | |
| operation picked | memory access operation was picked | | |
| in-order | to access the cache in program order. | | |
| Triggers | This state indicates that a tagged | | |
| Hardware | memory operation caused the | | |
| Prefetch | hardware-based prefetcher to make a | | |
| | data request | | |
| Cache Way | This multiple-bit state indicates the | | |
| | way of the cache in which a tagged | | |
| | memory operation hits. | | |
| | | Branch | This data provides |
| | | Predictor Used | which portion of the |
| | | | branch prediction logic |
| | | | was used to predict a |
| | | | tagged branch operation. |
| Dispatch stall | This set of states indicates the source | | |
| type | of the dispatch stalls encountered by a | | |
| | tagged operation | | |
| | | Memory probe | This data provides the |
| | | latency | number of clock cycles |
| | | | required for a memory |
| | | | system probe to |
| | | | completely return after |
| | | | being sent. |

As illustrated in the above table, the performance information that can be monitored includes a state that indicates that execution of a load or store operation for an address during an execution cycle resulted in a miss at a data cache, however a cache line is in the process of being filled with data that if present would have generated a cache hit. In a particular embodiment, performance monitoring information associated with memory accesses resulting from a cache miss for a particular data address will only be stored for the operation that resulted in the cache miss. In an alternative embodiment, performance monitoring information related to the memory access will be recorded for all operations that result in a cache miss, even if the execution cycle resulted in a hit on an already allocated data cache miss request.

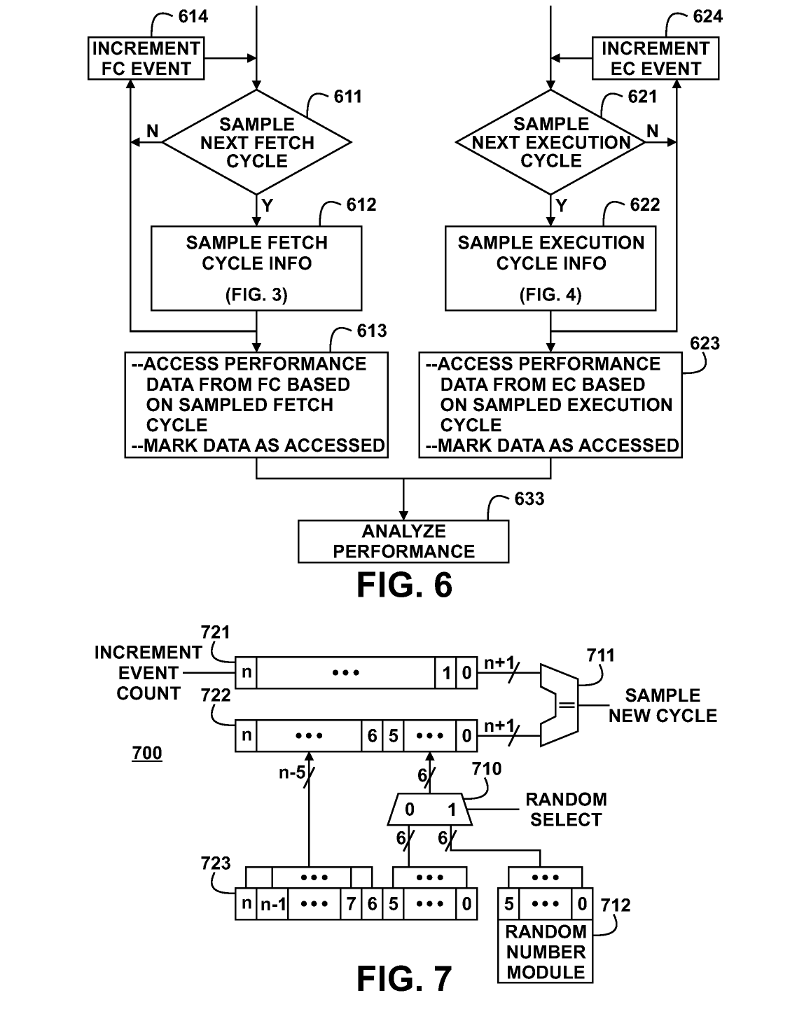

Referring to FIG. 6 a block diagram illustrating the decoupled nature of the performance sampling is illustrated. A first parallel path starts at block 611 where it is determined whether it is time to sample another fetch cycle. If so flow proceeds to block 612, otherwise, flow proceeds to block 614 where a fetch cycle event counter is incremented. In accordance with a specific embodiment the fetch cycle event counter is incremented upon completion of each fetch cycle.

At block 612, a specific fetch cycle is sampled as described at FIG. 3 to store performance information associated with a fetch cycle.

At block 613, the performance data sampled and stored at the integrated circuit at block 612 is accessed by analysis software. At block 633, the fetch cycle information is analyzed.

A parallel path including blocks 621-624 is illustrated.

At block 621 where it is determined whether it is time to sample an execution cycle fetch cycle. If so flow proceeds to block 622, otherwise, flow proceeds to block 624 where an execution cycle event counter is incremented. In accordance with a specific embodiment the execution cycle event counter is incremented upon completion of clock cycle. In another particular embodiment, the execution cycle event counter is incremented upon an instruction being retired. Note that the events that are monitored to determine when to sample fetch cycle information can be different events that are monitored to determine when to sample execution cycle information.

At block 622, a specific execution cycle is sampled as described at FIG. 4 to store performance information associated with an execution cycle.

At block 623, the performance data sampled and stored at the integrated circuit at block 622 is accessed by analysis software. At block 633, the execution cycle information is analyzed by software.

Referring to FIG. 7, a block diagram of a particular embodiment module 700 that asserts a signal labeled Sample New Cycle is illustrated. The module 700 can be implemented within performance tracking modules, such as performance tracking modules 240 and 25o of FIG. 2. As illustrated, module 700 includes a register 721, a register 822, and a register 723. The module 700 further includes a comparator 711, a multiplexer 710, and a random number module 812. The register 721 is increment in response to signal Increment Event Counter being asserted. The register 722 includes a first input, a second input, and an output. The comparator 711 includes a first input coupled to the output of the register 721 and a second input coupled to the output of the register 722, and an output to provide a sample new cycle indicator. A first set of bit locations of register 723, e.g. bits 6-n, is connected to a corresponding number of bit locations of register 722. A second set of bit locations of register 723, e.g., bits 0-5, is connected to a corresponding number of inputs of a multiplexer 710. The random number module 712 has a set of bit locations having the same number of bit locations as the of the second set of bit locations at register 722. These bit locations store a random number generated at the random number module 712. The set of bits at the random number module 712 are connected to a second input of multiplexer 710. Multiplexer 710 further includes a select input at which a signal Random Select is received.

During operation, the register 721 stores a value representing the number of events that have occurred. The register 722 stores a value representing a number of event that need to occur before asserting signal Sample New Signal. The comparator 711 compares the event count stored in the register 721 with the value stored in register 722, and will assert signal Sample New Cycle in response to the value at register 721 being equal to or greater than the value at register 722. Signal Sample New Cycle corresponds to the Periodic Signal of FIG. 5.

The register 723 stores a user programmable value that is used to set the value stored at register 722. When the signal Random Select is negated, the value at register 723 is provided to register 722 to set the desired threshold value. When the signal Random Select is asserted, only a portion of the most significant bits of the value at register 723 are provided to register 722 to set the desired threshold value with the remaining bits being provided by the random number module 712.

Thus the event threshold stored in the register 722 can be user programmable, but can also be adjusted by a random number offset. This allows for statistically significant sampling of fetch cycles or execution cycles in an instruction pipeline.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. Accordingly, the present disclosure is not intended to be limited to the specific form set forth herein, but on the contrary, it is intended to cover such alternatives, modifications, and equivalents, as can be reasonably included within the scope of the disclosure. For example, it will be appreciated that although some connections between modules and components have been illustrated as being unidirectional, those same connections could be bi-directional connections. Similarly, connections illustrated as bi-directional could be unidirectional connections in appropriate circumstances. In addition, although the different stages of an execution pipeline have been shown as separate portions, it will be appreciated that these portions could be combined. For example, the portions of the pipeline prior to the dispatch portion could be combined, and the portions of the pipeline after decoding could be combined. In addition, each engine of the instruction pipeline can be associated with multiple other engines in the instruction pipeline. For example, a fetch engine in the instruction pipeline could perform fetch operations for more than one execution engine. Similarly, an execution engine in the pipeline could receive operations based on memory accesses from multiple fetch engines. Further, it will be appreciated that with respect to the performance information disclosed above, additional or different performance information could be stored. For example, the duration of each stage in a pipeline engine cycle, such as the duration of each stage the fetch engine for a fetch cycle, could be recorded.

What is claimed is:

1. A method comprising:
in response to assertion of a first periodic sampling request, storing first performance information associated with processing first data at a first portion of an instruction pipeline;
in response to assertion of a second periodic sampling request, storing second performance information associated with processing second data at a second portion of the instruction pipeline, the assertion of the second periodic sampling request is decoupled from the assertion of the first periodic sampling request.

2. The method of claim 1, wherein the first portion comprises an instruction fetch portion of the instruction pipeline.

3. The method of claim 2, wherein the second portion comprises an execution portion of the instruction pipeline.

4. The method of claim 1, wherein the first performance information is selected from the group consisting of an instruction cache hit, an instruction cache miss, a translation look aside buffer miss, a translation look aside buffer hit, and a memory page size.

5. The method of claim 1, wherein the first performance information is selected from the group consisting of a data cache hit, a data cache miss, a translation look aside buffer miss, a translation look aside buffer hit and a memory page size.

6. The method of claim 1, further comprising:
generating a first interrupt in response to storing the first performance information; and
generating a second interrupt in response to storing the second performance information.

7. The method of claim 1, wherein a sampling period associated with the first periodic sampling request is based on a number of completed fetch cycles.

8. The method of claim 7, wherein the number of completed fetch cycles is randomized.

9. The method of claim 7, wherein a sampling period associated with the second periodic sampling request is based on a number of clock cycles.

10. The method of claim 9, wherein the number of clock cycles is randomized.

11. The method of claim 9, wherein the number of completed fetch cycles and the number of clock cycles are based on user programmable information.

12. The method of claim 7, wherein a sampling period associated with the second periodic sampling request is based on a number of retired instructions.

13. The method of claim 1, wherein the first data is associated with a first address, and the second data is an instruction being executed.

14. A device, comprising:
an instruction pipeline;
a first performance monitor coupled to a first portion of the instruction pipeline, the first performance monitor configured to store first performance information associated with processing a first request at the first portion in response to assertion of a first sampling request;
a second performance monitor coupled to a second portion of the instruction pipeline, the second performance monitor configured to store second performance information associated with processing a second request at the second portion in response to assertion of a second sampling request, wherein the assertion of the second sampling request is decoupled from the assertion of the first sampling request.

15. The device of claim 14, wherein the first portion comprises an instruction fetch portion of the instruction pipeline.

16. The device of claim 15, wherein the second portion comprises an execution portion of the instruction pipeline.

17. The device of claim 14, further comprising;
a first register coupled to the first performance monitor, wherein a sampling period associated with the first sampling request is to be based on a first value stored in the first register; and
a second register coupled to the second performance monitor, wherein a sampling period associated with the second sampling request is to be based on a second value stored in the second register.

18. The device of claim 17, further comprising a first comparator configured to compare the first value to a value at a third register configured to store a current number of fetch cycles, wherein the first sampling request is based on an output of the first comparator.

19. The device of claim 18, further comprising a second comparator configured to compare the second value to a value at a fourth register configured to store a current number of clock cycles, wherein the second sampling request is based on an output of the second comparator.

20. The device of claim 17, wherein the first value is randomized.

21. The device of claim 16, wherein the first value is to be based on user programmable information.

22. The device of claim 20, wherein the first value is to be based on randomized information.
